(19) United States
(12) Patent Application Publication
(10) Pub. No.: US 2008/0166160 A1
(43) Pub. Date: Jul. 10, 2008

(54) FIXING DEVICE AND IMAGE FORMING APPARATUS

(75) Inventors: Mamoru Fukaya, Nagoya-shi (JP); Kazunori Nishinoue, Toyohashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/961,636

(22) Filed: Dec. 20, 2007

(30) Foreign Application Priority Data
Jan. 4, 2007 (JP) 2007-000050

(51) Int. Cl. G03G 15/20

(52) U.S. Cl. 399/328

(57) ABSTRACT

A fixing device has a heating roller and a pressure belt, each of which includes a gripping portion at both width-directional ends thereof. The gripping portion corresponds to outside of a range in which a recording material passes. The gripping portion has a friction coefficient greater than that of the surface in the width-directional center portion, which portion corresponds to inside of the range in which the recording material passes. A gripping portion pressurizing part is located inside the gripping portion at both end portions of the pressure belt so as to pressurize the gripping portion of the pressure belt against the gripping portion of the heating roller. This makes it possible to improve frictional resistance between the gripping portions of the heating roller and the pressure belt. Thus, the fixing device allows preventing the conveyance error of the recording material, so that the image quality can be improved, and also the fixing device can be reduced in size and weight.

### CROSS-REFERENCE TO RELATED APPLICATIONS

This application is based on application No. 2007-000050 filed in Japan, the entire content of which is hereby incorporated by reference.

### BACKGROUND OF THE INVENTION

The present invention relates to a fixing device for use in a copying machine, a laser beam printer, a facsimile or the like for example, and to an image forming apparatus using the fixing device.

Conventionally, there has been a fixing device used in an image forming apparatus, which device has a heating roller and a pressure roller, wherein the heating roller is heated by a heat source and rotated by a driving force and the pressure roller comes in contact with the heating roller and is rotated driven by the rotation of the heating roller. A recording material is interposed between the heating roller and the pressure roller, and a toner image is melted by heating and fixed onto the recording material (refer to JP 2000-66545 A).

The heating roller has a smoothly formed surface in a region at the width-directional center and roughly formed surfaces in regions at both width-directional end portions, so that the friction between the heating roller and the recording material becomes small in the center portion. On the other hand, both the width-directional end portions of the pressure roller have smoothly formed surfaces.

In the conventional fixing device, however, the surfaces of both the end portions of the heating roller are roughly formed while the surfaces of both the end portions of the pressure roller are smoothly formed. Accordingly, there has been a problem of reducing the frictional resistance between the heating roller and the pressure roller. This is because the heating roller and the pressure roller contact with each other only at both the end portions of the heating roller and both the end portions of the pressure roller, wherein those end portions are located outside of the passing region of the recording material when the recording material passes between the heating roller and the pressure roller.

Therefore, the conveyance capability of the recording material by the heating roller and the pressure roller is reduced, so that a slip occurs between the heating roller and the pressure belt. This causes a velocity difference between the recording material and the heating roller, and consequently an image noise generates.

Moreover, there occurs a problem of increase in the width dimension of the fixing device when the width of both the end portions of the heating roller is lengthened so as to increase the conveyance capability of the recording material. On the other hand, there occurs a problem of increase in the weight of the fixing device when the pressure contact force of the recording material is increased. This is because a need for increasing the frame strength of the fixing device for the prevention of bending arises, and the frame thickness must be increased.

### BRIEF SUMMARY OF THE INVENTION

An object of the present invention is to provide a fixing device capable of preventing the conveyance error of the recording material, which makes it possible to improve the image quality and to make reduction in size and weight.

In order to achieve the above-mentioned object, one aspect of the present invention provides a fixing device comprising: a heating rotation unit heated by a heat source and rotated by a driving force; an endless pressure belt contacted with exterior of the heating rotation unit and driven by the rotation of the heating rotation unit; and a pressurizing member placed inside the pressure belt and pressurizes the pressure belt against the heating rotation unit to form a nip portion that holds a recording material between the heating rotation unit and the pressure belt, wherein a gripping portion is provided at least at one width-directional end portion, which portion corresponds to outside of a range in which the recording material passes for the heating rotation unit and the pressure belt, and has a friction coefficient greater than a friction coefficient of a surface of a width-directional center portion, which portion corresponds to inside of the range in which the recording material passes, and a gripping portion pressurizing part is located inside the gripping portion at least at one end portion of the pressure belt, and pressurizes the gripping portion of the pressure belt against the gripping portion of the heating rotation unit.

According to the fixing device of the present invention, the gripping portion of the heating rotation unit and the gripping portion of the pressure belt are reliably brought in pressure contact with each other. Therefore, it becomes possible to improve the frictional resistance between the gripping portion of the heating rotation unit and the gripping portion of the pressure belt. As the result, the pressure belt can reliably be rotated driven by the rotation of the heating rotation unit.

Thus, the conveyance capability of the recording material exerted by the heating rotation unit and the pressure belt is not reduced even when the recording material having a small friction coefficient passes through the nip portion. Therefore, it becomes possible to prevent a slip between the heating rotation unit and the pressure belt. As the result, the velocity difference disappears between the recording material and the heating rotation unit. This prevents generation of noise in image. Also, the conveyance capability of the recording material needs not be increased, and therefore the width of the gripping portion needs not be increased, so that reduction in size can be achieved by reducing the width dimension of the fixing device. Further, the pressure contact force in the nip portion needs not be increased, and therefore the frame strength of the fixing device needs not be increased for the prevention of bending, so that reduction in weight can be achieved by thinning the frame thickness.

As described above, it is possible to improve the frictional resistance between the heating rotation unit and the pressure belt outside the range in which the recording material passes. Thereby, the conveyance error of the recording material can be prevented to improve the image quality so that the fixing device can be reduced in size and weight.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic structural view of an image forming apparatus according to a first embodiment of the present invention;

FIG. 2 shows a schematic structural view of a fixing device according to the first embodiment of the present invention;

FIG. 3 shows a front view of a heating roller and a pressure belt;

FIG. 4 shows a sectional view of the heating roller;

FIG. 5 shows a sectional view of the pressure belt;

FIG. 6 shows a sectional view of a heating roller of the fixing device according to a second embodiment of the present invention;

FIG. 7 shows a sectional view of the heating roller of the fixing device according to a third embodiment of the present invention;

FIG. 8 shows a sectional view of the heating roller of the fixing device according to a fourth embodiment of the present invention;

FIG. 9 shows a sectional view of the heating roller of the fixing device according to a fifth embodiment of the present invention;

FIG. 10 shows a sectional view of the heating roller of the fixing device according to a sixth embodiment of the present invention;

FIG. 11 shows a sectional view of a pressure belt of the fixing device according to a seventh embodiment of the present invention; and

FIG. 12 shows a sectional view of the pressure belt of the fixing device according to an eighth embodiment of the present invention.

### DETAILED DESCRIPTION OF THE INVENTION

The present invention will be described in detail below by the embodiments shown in the drawings.

### First Embodiment

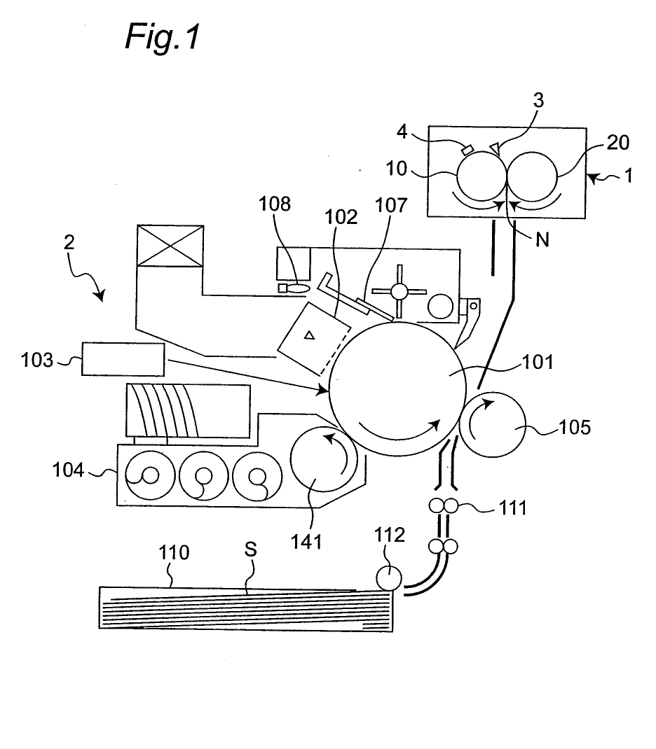

FIG. 1 shows a schematic structural view of an image forming apparatus according to a first embodiment of the present invention. The image forming apparatus includes an imaging device 2 that forms an image by making an unfixed toner adhere to a recording material S and a fixing device 1 that melts the toner and fixes the same onto the recording material S.

The imaging device 2 includes a photoconductor 101, a developer 104 that forms a toner image on the surface of the photoconductor 101, and a transfer roller 105 that transfers the toner image on the photoconductor 101 onto the recording material S.

The fixing device 1 has a heating roller 10, as a heating rotation unit, and an endless pressure belt 20. The endless pressure belt 20 comes in contact with the exterior of the heating roller 10 and is rotated driven by the rotation of the heating roller 10. A nip portion N is formed between the heating roller 10 and the pressure belt 20. A separator pawl 3 and a thermistor 4 are placed on the outer peripheral surface of the heating roller 10.

Operation of the image forming apparatus is described next.

The surface of the photoconductor 101 is uniformly charged to a prescribed electrical potential by a charger 102. Image exposure is carried out in the charging region by using light from an image exposure device 103 corresponding to the original image, so that an electrostatic latent image is formed on the photoconductor 101. The electrostatic latent image is developed by a developer roller 141 in the developer 104 and formed into a visible toner image, wherein a developing bias is applied to the developer roller 141.

On the other hand, the recording materials S are drawn one by one out of a cassette 110, which accommodates the recording materials S such as recording papers by a feed roller 112, and fed to a pair of timing rollers 111. The timing rollers 111 send the recording material S into a space between the photoconductor 101 and the transfer roller 105 to which a transfer voltage is applied in synchronization with the toner image on the photoconductor 101.

Subsequently, the recording material S is made to pass through the mutual nip portion of the photoconductor 101 and the transfer roller 105. Thereby, the toner image is transferred onto the recording material S. The toner image is subsequently fixed on the recording material S under heating and pressurization by the fixing device 101.

To get ready for the next image formation after transfer, a cleaner 107 removes toner remaining on the photoconductor 101 so as to cleaned it away from the photoconductor 101, and an eraser 108 erases the residual electricity.

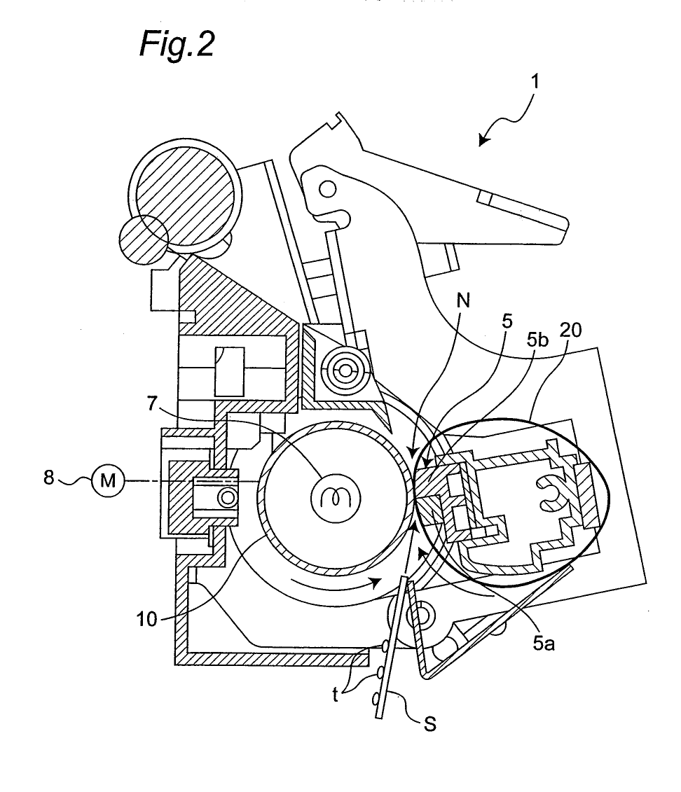

The heating roller 10 shown in FIG. 2 is heated by a heater 7 as a heat source placed inside and rotated by a motor 8 as a driving force. A pressurizing member 5 is placed inside the pressure belt 20. The pressurizing member 5 pressurizes the pressure belt 20 against the heating roller 10 so as to form the nip portion N that holds the recording material S between the heating roller 10 and the pressure belt 20.

The recording material S is conveyed by the nip portion N while the toner t is melted and fixed onto the recording material S. The recording material S is, for example, a paper sheet, an OHP sheet or the like. The toner t is constructed of a thermo-fusible material made out of a resin, a magnetic substance, a colorant and the like, for example.

The heating roller 10 has at least a core metal and a surface layer. The core metal should desirably be made of a metal such as aluminum or iron and have a pipe-like shape of a thickness of, about 0.1 to 5 mm. It is desirable that the thickness should be about 0.2 to 1.5 mm in consideration of weight reduction and warm-up time.

A fluorine system tube of PFA, PTFE, ETFE or the like may be used for the surface layer. The surface layer may also be provided with a fluorine system coating or a silicone system coating or the like having a mold release property or an electrically conductive property. The surface layer should desirably have a thickness of about 5 to 100 μm. Examples of the fluorine system tube include PFA350-J, 451HP-J, 951HP Plus and the like produced by Du Pont-Mitsui Fluorochemicals Co., Ltd. The surface layer should desirably have a surface roughness Ra of about 0.01 to 50 μm.

An interlayer may be provided between the surface layer and the core metal. The interlayer is made of an elastic material such as silicone rubber or fluoro-rubber which preferably has a material quality of high heat resistance. Thickness of the interlayer is arbitrary, but it should be desirably about 0.05 to 2 mm. An outside diameter of the interlayer is also arbitrary, but it should be desirably 10 to 50 mm.

The pressure belt 20 has at least a base material and a surface layer. The base material is made of polyimide, polyphenylene sulfide, nickel, iron or the like.

As stated above, it is acceptable to use a fluorine system tube of PFA, PTFE, ETFE or the like for the surface layer. The surface layer may also be provided with a fluorine system coating or a silicone system coating or the like having a mold release property or an electrically conductive property. The surface layer should desirably have a thickness of about 5 to 100 μm.

An interlayer may be provided between the surface layer and the core metal. The interlayer is made of an elastic material such as silicone rubber or fluoro-rubber which preferably has a material quality of high heat resistance. Thickness of the interlayer is arbitrary, but it should be desirably about 0.05 to 2 mm. An outside diameter of the interlayer is also arbitrary, but it should be desirably 10 to 50 mm.

A lubricant such as grease may be applied to the inner surface of the pressure belt 20. Although the grease is arbitrary, it is preferably made of a fluorine system material, a silicone system material, a polyolefin system material, a mineral oil system material or the like.

The pressurizing member 5 has an elastic pad 5a located on the upstream side in the direction of conveying the recording material S and a rigid pad 5b located on the downstream side of the elastic pad 5a.

An elastic material such as silicone system rubber or fluorine system rubber is used for the elastic pad 5a. The pad should desirably have a material quality of high heat resistance. Thickness of the pad is arbitrary, but it should be desirably about 0.1 to 10 mm.

The rigid pad 5b is made of a resin such as polyphenylene sulfide, polyimide or liquid crystal polymer, a metal such as aluminum or iron, ceramic or the like.

The shapes of the elastic pad 5a and the rigid pad 5b are arbitrary. The elastic pad 5a and the rigid pad 5b may be assembled integrally with a support member made of a metallic plate of SUS, aluminum, iron or the like in terms of assemblability, productivity and so on. It is also acceptable to place another heat source or to place another rotation unit such as a roller at the support member.

The shape of the nip portion N is determined by the shapes of the elastic pad 5a and the rigid pad 5b, the rubber layer thickness of the heating roller 10, the thickness of the elastic pad 5a, a pressure applied to the nip portion N and so on. A load applied to the nip portion N is arbitrary, but it should desirably be 100 to 600 N.

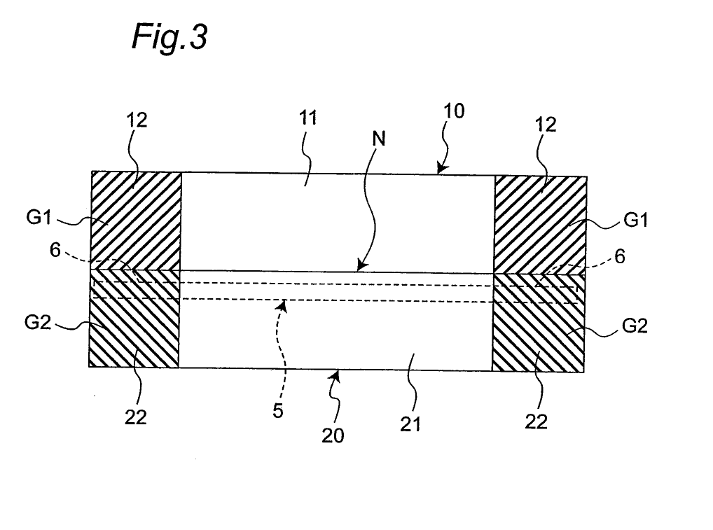

As shown in FIG. 3, the heating roller 10 is provided with gripping portions G1 (indicated by hatching) at both width-directional end portions 12, where the end portions 12 correspond to the outside of the range in which the recording material S passes. The gripping portions G1 have a friction coefficient greater than the friction coefficient of the surface of a width-directional center portion 11, where the center portion 11 corresponds to the inside of the range in which the recording material S passes.

The pressure belt 20 is provided with gripping portions G2 (indicated by hatching) at both width-directional end portions 22, where the end portions correspond to the outside of the range in which the recording material S passes. The gripping portions G2 have a friction coefficient greater than the friction coefficient of the surface of a width-directional center portion 21, where the center portion 21 corresponds to the inside of the range in which the recording material S passes.

The gripping portions G1 and G2 are preferably located only outside the range in which the recording material S passes. This is because if a toner exists on the surface of the recording material S, the toner melts to reduce the friction coefficient and deteriorate the conveyance performance. It is noted that the range in which the recording material S passes is defined as a range in which the recording material S of the maximum width that the fixing device passes can process.

The gripping portions G1 and G2 each have a width that is 1/100 to 3/10 the total width of the heating roller 10 and the pressure belt 20, respectively. This range of width makes it possible to prevent the increase in size of the fixing device while securing the conveyance performance of the recording material S. In contrast to this, when the width is smaller than 1/100, the conveyance performance of the recording material S cannot be secured. Also, when the width is greater than 3/10, the fixing device is disadvantageously increased in size.

A gripping portion pressurizing part 6 is located inside the gripping portions G2 at both end portions of the pressure belt 20, and pressurizes the gripping portions G2 of the pressure belt 20 against the gripping portions G1 of the heating roller 10.

Both end portions of the pressurizing member 5 is located inside both end portions 22 of the pressure belt 20, and constitute the gripping portion pressurizing part 6 which pressurizes the gripping portions G2 at both end portions 22 of the pressure belt 20 against the gripping portions G1 at both end portions 12 of the heating roller 10.

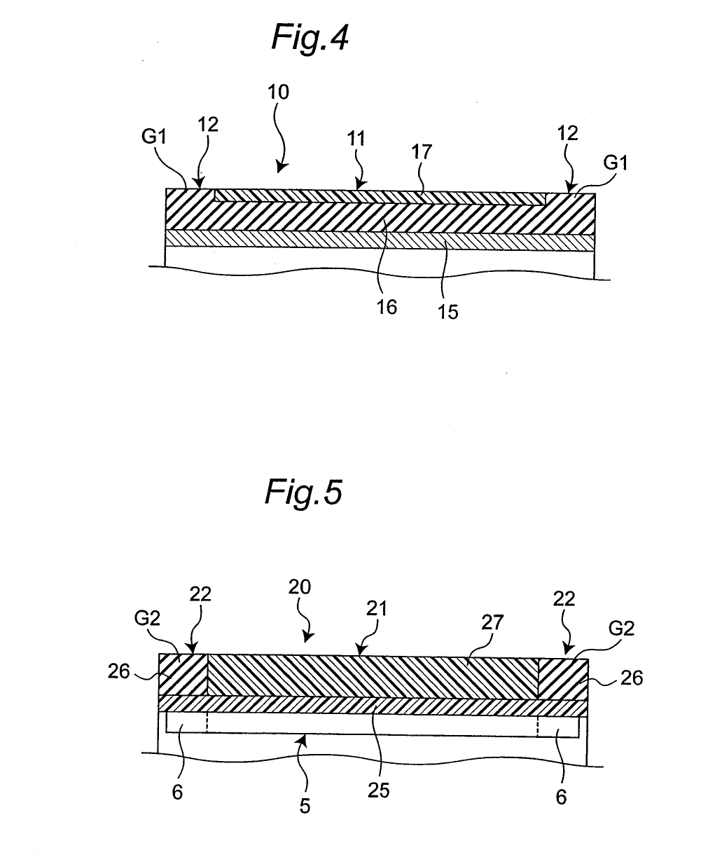

As shown in FIG. 4, the heating roller 10 has the core metal 15, an elastic member 16 and a mold release member 17 arranged in order from the inside to the outside. The core metal 15 is made of, for example, iron. The elastic member 16 is made of, for example, silicone rubber. The mold release member 17 is made of, for example, fluorine system resin.

The elastic member 16 has a recess in a portion corresponding to the center portion 11. The mold release member 17 is located to fit into the recess.

That is, the end portions 12 are constructed of the core metal 15 and the elastic member 16 in order from the inside to the outside. The center portion 11 is made of the core metal 15, the elastic member 16 and the mold release member 17 in order from the inside to the outside.

The gripping portions G1 are constructed of the elastic member 16. The gripping portions G1 have hardness lower than that of the surface in the center portion 11. The gripping portions G1 at both end portions and the portion inside i.e. under the surface of the center portion 11 are integrally continued into each other and made of the identical elastic member 16.

As shown in FIG. 5, the pressure belt 20 has a substrate 25, elastic members 26 and a mold release member 27 which are located outside the substrate 25. The substrate 25 is made of, for example, polyimide. The elastic members 26 are made of, for example, silicone rubber. The mold release member 27 is made of, for example, fluorine system resin.

The elastic members 26 are located at portions corresponding to the end portions 22. The mold release member 27 is located at a portion corresponding to the center portion 21.

That is to say, the end portions 22 are constructed of the substrate 25 and the elastic members 26 in order from the inside to the outside. The center portion 21 is constructed of the substrate 25 and the mold release member 27 in order from the inside to the outside.

Gripping portions G2 are constructed of the elastic members 26. The gripping portions G2 have hardness lower than the hardness of the surface of the center portion 21. The gripping portion pressurizing part 6 of the pressurizing member 5 is located inside the gripping portions G2.

As described above, the friction coefficient can be increased by mutual contact between the gripping portions G1 and G2 made of silicone rubber. This is apparent from the relations between the friction coefficient and materials, as shown in Table 1 below.

TABLE 1

| Construction | | |
|---|---|---|
| Heating Roller | Pressure Belt | Friction coefficient |
| Fluorine System | Fluorine System | 0.5 |
| Material | Material | |
| Fluorine System | Silicone Rubber | 2.0 |
| Material | | |
| Silicone Rubber | Silicone Rubber | 5.0 |

According to the fixing device of the above construction, the heating roller 10 and the pressure belt 20 have the gripping portions G1 and G2, respectively at both the end portions 12 and 22. The width-directional end portions 12 and 22 correspond to the outside of the range in which the recording material S passes. The gripping portions G1 and G2 have a friction coefficient greater than the friction coefficient of the surfaces of the center portions 11 and 21. The width-directional center portions 11 and 21 correspond to the inside of the range in which the recording material S passes. The gripping portion pressurizing part 6 is located inside the gripping portions G2 at both the end portions 22 of the pressure belt 20, so that the gripping portion pressurizing part 6 pressurizes the gripping portions G2 of the pressure belt 20 against the gripping portions G1 of the heating roller 10. Thus, the gripping portions G1 of the heating roller 10 and the gripping portions G2 of the pressure belt 20 are reliably brought in pressure contact with each other. Therefore, it is possible to improve the friction between the gripping portions G1 of the heating roller 10 and the gripping portions G2 of the pressure belt 20, which allows the pressure belt 20 to be reliably rotated driven by the rotation of the heating roller 10.

Therefore, even when the recording material S having a small friction coefficient is made to pass through the nip portion N, the conveyance capability of the recording material S by the heating roller 10 and the pressure belt 20 is not reduced. Therefore, it is possible to prevent a slip between the heating roller 10 and the pressure belt 20, consequently, to remove difference in the velocity between the recording material S and the heating roller 10. This prevents the generation of an image noise. Moreover, since the conveyance capability of the recording material S needs not be increased, the gripping portions G1 and G2 need not be increased in width. This allows the width dimension of the fixing device to be reduced for the achievement of size reduction. Moreover, since the pressure contact force in the nip portion N needs not be increased, the frame strength of the fixing device needs not be increased for the prevention of bending, which allows the frame thickness to be reduced for the achievement of weight reduction.

As described above, it is possible to improve the frictional resistance between the heating roller 10 and the pressure belt 20 outside the range in which the recording material S passes. This prevents the conveyance error of the recording material S, so that the image quality is not only improved, but also the fixing device can be reduced in size and weight.

Moreover, the gripping portions G1 and G2 are provided at both width-directional end portions 12 of the heating roller 10 and at both end portions 22 of the pressure belt 20 respectively, and therefore, it is possible to further improve the conveyance capability of the recording material S by the heating roller 10 and the pressure belt 20.

Moreover, both the end portions of the pressurizing member 5 are located inside both the end portions 22 of the pressure belt 20, and constitute the gripping portion pressurizing parts 6 which pressurizes the gripping portions G2 at both end portions 22 of the pressure belt 20 against the gripping portions G1 at both end portions 12 of the heating roller 10. Therefore, the pressurizing member 5 can concurrently be used for not only forming the nip portion N but also improving the frictional resistance between the gripping portions G1 of the heating roller 10 and the gripping portions G2 of the pressure belt 20.

Moreover, the gripping portions G1 and G2 are constructed of the elastic members 16 and 26. Therefore, the friction of the gripping portions G1 and G2 can easily be increased. Also, the mutual contact area of the gripping portions G1 and G2 can be increased by the elastic deformations of the gripping portions G1 and G2. This allows the frictional resistance to be improved.

Moreover, the gripping portions G1 and G2 has hardness lower than that of the surfaces of the center portions 11 and 21. Therefore, the gripping portions G1 and G2 can be more easily elastically deformed, so that the mutual contact area of the gripping portions G1 and G2 can be increased. As the result, the frictional resistance therebetween can be improved.

Moreover, the gripping portions G1 at both the end portions of the heating roller 10 continue integrally into the portion inside the surface of the center portion 11 of the heating roller 10. Thus, the heating roller 10 can easily be manufactured, and durability can be improved.

Moreover, the gripping portions G1 and the inside portion of the center portion 11 are made of the identical elastic member 16. Therefore, the friction coefficient of the gripping portions G1 can easily be increased. Also, the gripping portions G1 is elastically deformed, so that the contact area to the other gripping portions G2 can be increased. This allows the frictional resistance to be improved.

Moreover, the image forming apparatus has the fixing device described above, and therefore the image quality can be improved, and reductions in size and weight can be achieved.

### Second Embodiment

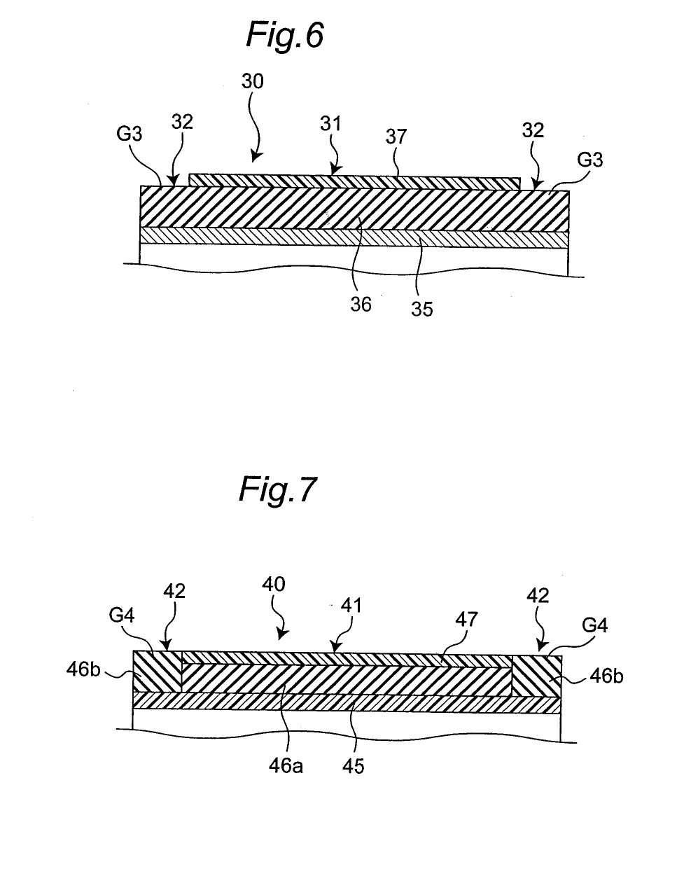

FIG. 6 shows the fixing device according to a second embodiment of the present invention. The fixing device of the second embodiment differs from that of the first embodiment (FIG. 4) in the construction of the heating roller.

As shown in FIG. 6, a heating roller 30 of the second embodiment has a core metal 35, an elastic member 36 and a mold release member 37 in order from the inside to the outside. The core metal 35 is made of, for example, iron. The elastic member 36 is made of, for example, silicone rubber. The mold release member 37 is made of, for example, fluorine system resin. The mold release member 37 is located in a center portion 31.

That is to say, end portions 32 are constructed of the core metal 35 and the elastic member 36 in order from the inside to the outside. The center portion 31 is constructed of the core metal 35, the elastic member 36 and the mold release member 37 in order from the inside to the outside.

Gripping portions G3 are constructed of the elastic member 36. The gripping portions G3 at both end portions continue integrally into a portion inside the surface of the center portion 31. The gripping portions G3 and the portion inside the center portion 31 are made of the identical elastic member 36.

### Third Embodiment

FIG. 7 shows the fixing device according to a third embodiment of the present invention. The fixing device of the third embodiment differs from that of the first embodiment (FIG. 4) in the construction of the heating roller.

As shown in FIG. 7, a heating roller 40 of the third embodiment has a core metal 45, a first elastic member 46a and second elastic members 46b which are located outside the core metal 45, and a mold release member 47 which is located outside the first elastic member 46a.

The core metal 45 is made of, for example, iron. The first elastic member 46a and the second elastic members 46b are made of, for example, silicone rubber. The mold release member 47 is made of, for example, fluorine system resin.

The first elastic member 46a is located in a center portion 41, the second elastic members 46b are located at end portions 42, and the mold release member 47 is located in the center portion 41.

That is to say, the end portions 42 are constructed of the core metal 45 and the second elastic members 46b in order from the inside to the outside. The center portion 41 is constructed of the core metal 45, the first elastic member 46a and the mold release member 47 in order from the inside to the outside.

Gripping portions G4 are constructed of the second elastic members 46b. The second elastic members 46b of the gripping portions G4 at both the end portions and the first elastic member 46a in the portion inside the surface of the center portion 41 are separately processed and separate bodies.

### Fourth Embodiment

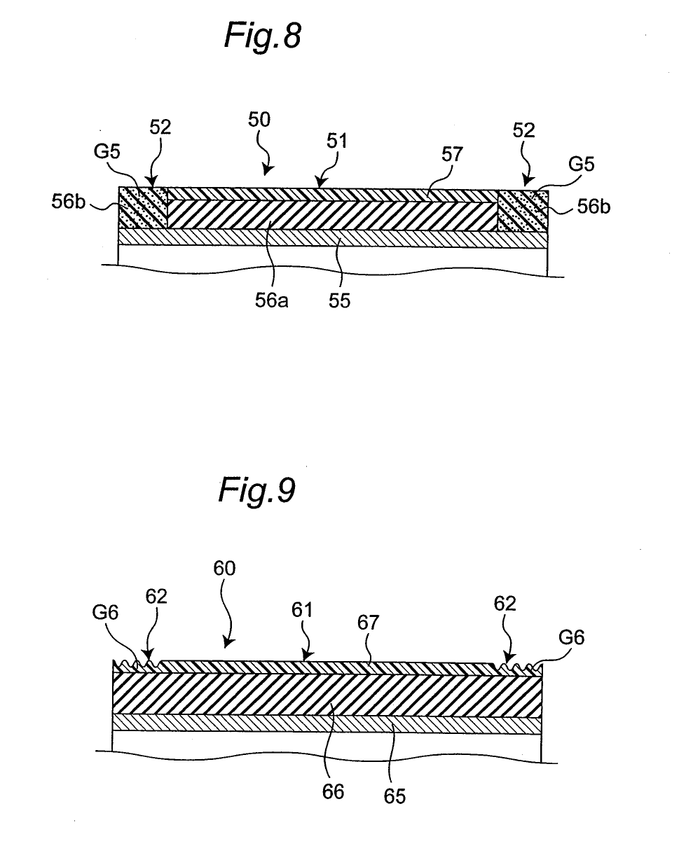

FIG. 8 shows the fixing device according to a fourth embodiment of the present invention. The fixing device of the fourth embodiment differs from that of the first embodiment (FIG. 4) in the construction of the heating roller.

As shown in FIG. 8, a heating roller 50 of the fourth embodiment has a core metal 55, a first elastic member 56a and second elastic members 56b which are located outside the core metal 55, and a mold release member 57 which is located outside the first elastic member 56a.

The core metal 55 is made of, for example, iron. The first elastic member 56a is made of, for example, silicone rubber. The second elastic members 56b are made of, for example, a silicone sponge as heatproof foam. The mold release member 57 is made of, for example, fluorine system resin.

The first elastic member 56a is located in a center portion 51. The second elastic members 56b are located at end portions 52. The mold release member 57 is located in the center portion 51.

That is to say, the end portions 52 are constructed of the core metal 55 and the second elastic members 56b in order from the inside to the outside. The center portion 51 is constructed of the core metal 55, the first elastic member 56a and the mold release member 57 in order from the inside to the outside.

Gripping portions G5 are constructed of the second elastic members 56b. The second elastic members 56b of the gripping portions G5 at both the end portions and the first elastic member 56a in the portion inside the surface of the center portion 51 are separately processed and separate bodies.

The gripping portions G5 are made of heatproof foam. Therefore, the gripping portions G5 can be made flexible, and the contact area to the other gripping portions can be increased by the elastic deformations of the gripping portions G5. This allows the frictional resistance to be improved. The second elastic members 56b may be foam of fluoro-rubber.

### Fifth Embodiment

FIG. 9 shows the fixing device according to a fifth embodiment of the present invention. The fixing device of the fifth embodiment differs from that of the first embodiment (FIG. 4) in the construction of the heating roller.

As shown in FIG. 9, a heating roller 60 of the fifth embodiment has a core metal 65, an elastic member 66 and a mold release member 67 in order from the inside to the outside.

The core metal 65 is made of, for example, iron. The elastic member 66 is made of, for example, silicone rubber. The mold release member 67 is made of, for example, fluorine system resin.

The surface of the mold release member 67 is smoothly formed in a center portion 61, and formed in an undulated shape at end portions 62.

That is to say, the end portions 62 are constructed of the core metal 65, the elastic member 66 and the mold release member 67 having the undulated portions, in order from the inside to the outside. The center portion 61 is constructed of the core metal 65, the elastic member 66 and the mold release member 67 having the smooth portion, in order from the inside to the outside.

Gripping portions G6 are constructed of the mold release member 67 having the undulated portions. The surfaces of the gripping portions G6 are formed into the undulated shape, and therefore, it is not necessary to employ other members made of a material different from that of the surface in the center portion 61. As the result, it is possible to reduce the number of parts.

In addition, the undulated surface of the gripping portions G6 may be formed by transfer of a mold, or may be formed by post-processing.

Sheet conveyability and image quality become more excellent in the pressure belt 20 shown in FIG. 3 if the surfaces of the gripping portions G2 are formed into the undulated shape. This is apparent from the relations between surface roughness and friction coefficient as shown in Table 2 below.

TABLE 2

| | Surface Roughness Ra (μm) | | | | | | | |
|---|---|---|---|---|---|---|---|---|
| | Heating Roller | | Pressure Belt | | Friction coefficient | | Quality | |
| | Center | Gripping | Center | Gripping | Center | Gripping | Sheet | Image |
| No. | Portion | Portion | Portion | Portion | Portion | Portion | Conveyability | Quality |
| 1 | 0.1 | 1.0 | 0.1 | 1.0 | 0.5 | 5.0 | ∘ | ∘ |
| 2 | 0.07 | 3.0 | 0.2 | Zero | 0.6 | 2.0 | Δ | Δ |
| 3 | 0.15 | Zero | 0.25 | Zero | 0.6 | — | x | x |

### Sixth Embodiment

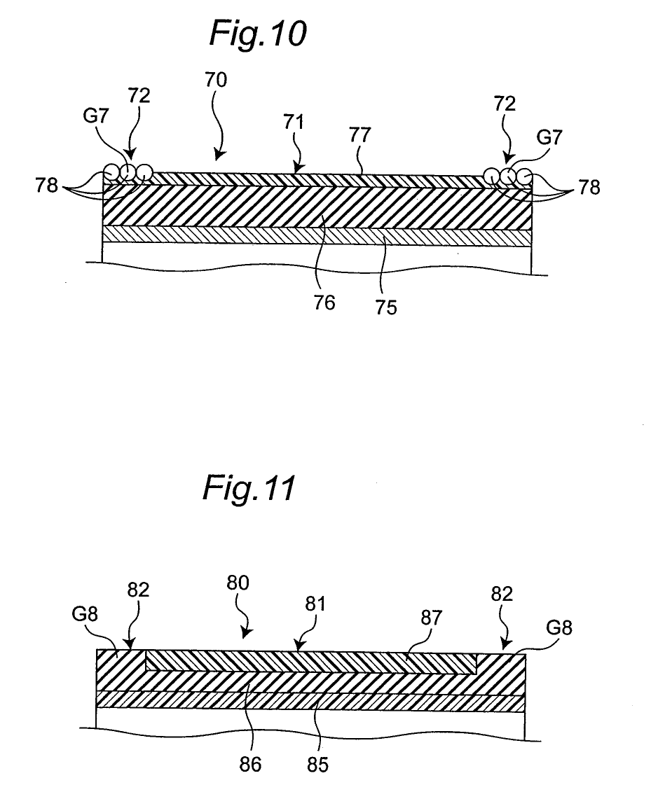

FIG. 10 shows the fixing device according to a sixth embodiment of the present invention. The fixing device of the sixth embodiment differs from that of the first embodiment (FIG. 4) in the construction of the heating roller.

As shown in FIG. 10, a heating roller 70 of the sixth embodiment has a core metal 75, an elastic member 76 and a mold release member 77 in order from the inside to the outside.

The core metal 75 is made of, for example, iron. The elastic member 76 is made of, for example, silicone rubber. The mold release member 77 is made of, for example, fluorine system resin.

The surface of the mold release member 77 is smoothly formed in a center portion 71 and provided with fiber portions 78 at end portions 72. The fiber portions 78 are made of, for example, aramid fiber.

That is to say, the end portions 72 are constructed of the core metal 75, the elastic member 76 and the fiber portions 78 in order from the inside to the outside. The center portion 71 is constructed of the core metal 75, the elastic member 76 and the mold release member 77 in order from the inside to the outside. The gripping portions G7 are constructed of the fiber portions 78. The surface of the gripping portions G7 is formed in an undulated shape.

### Seventh Embodiment

FIG. 11 shows the fixing device according to a seventh embodiment of the present invention. The fixing device of the seventh embodiment differs from that of the first embodiment (FIG. 4) in the construction of the pressure belt.

As shown in FIG. 11, a pressure belt 80 has a substrate 85, an elastic member 86 and a mold release member 87 in order from the inside to the outside. The substrate 85 is made of, for example, polyimide. The elastic member 86 is made of, for example, silicone rubber. The mold release member 87 is made of, for example, fluorine system resin.

The elastic member 86 has a recess in a portion corresponding to a center portion 81, and the mold release member 87 is located in the recess.

That is to say, end portions 82 are constructed of the substrate 85 and the elastic member 86 in order from the inside to the outside. The center portion 81 is constructed of the substrate 85, the elastic member 86 and the mold release member 87 in order from the inside to the outside.

Gripping portions G8 are constructed of the elastic member 86. The gripping portions G8 have hardness lower than the hardness of the surface of the center portion 81. The gripping portions G8 at both end portions continue integrally into with a portion inside the surface of the center portion 81. The gripping portions G8 and the portion inside the center portion 81 are made of the identical elastic member 86.

### Eighth Embodiment

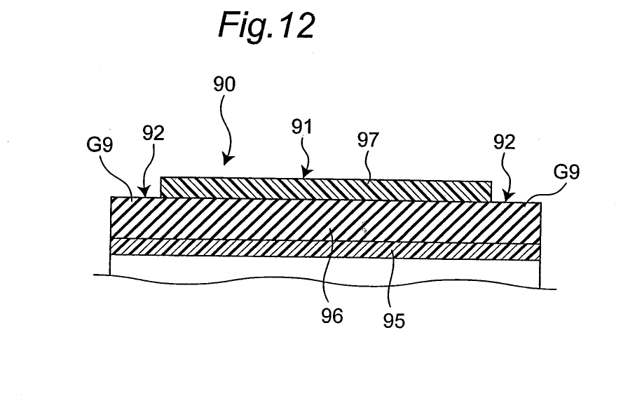

FIG. 12 shows the fixing device according to an eighth embodiment of the present invention. The fixing device of the eighth embodiment differs from that of the first embodiment (FIG. 4) in the construction of the pressure belt.

As shown in FIG. 12, a pressure belt 90 of the eighth embodiment has a substrate 95, an elastic member 96 and a mold release member 97 in order from the inside to the outside. The substrate 95 is made of, for example, polyimide. The elastic member 96 is made of, for example, silicone rubber. The mold release member 97 is made of, for example, fluorine system resin. The mold release member 97 is located in a center portion 91.

That is to say, end portions 92 are constructed of the substrate 95 and the elastic member 96 in order from the inside to the outside. The center portion 91 is constructed of the substrate 95, the elastic member 96 and the mold release member 97 in order from the inside to the outside.

Gripping portions G9 are constructed of the elastic member 96. The gripping portions G9 at both end portions continue integrally into a portion inside the surface of the center portion 91. The gripping portions G9 and the portion inside the surface of the center portion 91 are made of the identical elastic member 96.

In the first through eighth embodiments, the heating roller and the pressure belt is formed by a manufacturing method, wherein the elastic member made of rubber is formed in the center portion and the gripping portions by injection-molding or coating with a blade, spraying, dipping or the like. Thereafter, a mold release member may be covered as a surface layer. Alternatively, a mold release member, as a surface layer, may be concurrently laid only in the center portion during molding. Also, there may be a method wherein only the gripping portions are formed by extrusion molding or the like, and thereafter the mold release member is inserted. Only the gripping portions may be formed by spring rubber or the like. It is also acceptable to remove the member that has a mold release property as the surface layer at the end portions so as to expose rubber as an interlayer on the surface.

The present invention is limited to none of the embodiments described above. For example, it is acceptable to provide the gripping portion at least at one end portion of each of the heating roller and the pressure belt.

It is acceptable to form the gripping portion on at least one of the heating roller and the pressure belt as in the first through eighth embodiments.

It is acceptable to provide only the elastic pad 5a as the pressurizing member 5. Moreover, the gripping portion pressurizing part 6 may be constructed of a member separated from the pressurizing member 5.

The heating rotation unit may be a belt besides the heating roller 10. The heater 7 may be placed outside the heating roller 10. Electromagnetic induction heating may be used as a heat source for heating the heating roller 10.

The image forming apparatus may be any one of a monochrome/color copying machine, a printer, a facsimile and a composite machine of them.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

What is claimed is:

1. A fixing device comprising:
a heating rotation unit heated by a heat source and rotated by a driving force;
an endless pressure belt contacted with exterior of the heating rotation unit and driven by the rotation of the heating rotation unit; and
a pressurizing member placed inside the pressure belt and pressurizes the pressure belt against the heating rotation unit to form a nip portion that holds a recording material between the heating rotation unit and the pressure belt, wherein
a gripping portion is provided at least at one width-directional end portion, which portion corresponds to outside of a range in which the recording material passes for the heating rotation unit and the pressure belt, and has a friction coefficient greater than a friction coefficient of a surface of a width-directional center portion, which portion corresponds to inside of the range in which the recording material passes, and
a gripping portion pressurizing part is located inside the gripping portion at least at one end portion of the pressure belt, and pressurizes the gripping portion of the pressure belt against the gripping portion of the heating rotation unit.

2. The fixing device as claimed in claim 1, wherein
the gripping portion is provided at both width-directional end portions of the heating rotation unit and at both width-directional end portions of the pressure belt.

3. The fixing device as claimed in claim 1, wherein
at least the one end portion of the pressurizing member is located inside at least one end portion of the pressure belt, and constitutes the gripping portion pressurizing part which pressurizes the gripping portion of at least one end portion of the pressure belt against the gripping portion of at least one end portion of the heating rotation unit.

4. The fixing device as claimed in claim 1, wherein
the gripping portion is formed out of an elastic member with regard to at least one of the heating rotation unit and the pressure belt.

5. The fixing device as claimed in claim 1, wherein
the gripping portion has hardness lower than surface hardness of the center portion with regard to at least one of the heating rotation unit and the pressure belt.

6. The fixing device as claimed in claim 1, wherein
the gripping portion at least at the one end continues integrally into a portion inside the surface of the center portion with regard to at least one of the heating rotation unit and the pressure belt.

7. The fixing device as claimed in claim 6, wherein
the gripping portion and the portion inside the center portion are formed out of an identical elastic member.

8. The fixing device as claimed in claim 1, wherein
the gripping portion has a surface formed in an undulated shape with regard to at least one of the heating rotation unit and the pressure belt.

9. The fixing device as claimed in claim 1, wherein
the gripping portion is formed out of heatproof foam with regard to at least one of the heating rotation unit and the pressure belt.

10. An image forming apparatus comprising the fixing device claimed in claim 1.
